(19) United States
(12) Patent Application Publication
(10) Pub. No.: US 2006/0146221 A1
(43) Pub. Date: Jul. 6, 2006

(54) Liquid crystal display device and manufacturing method therefor

(75) Inventors: Shigeru Tabata, Ishikawa (JP); Hideyuki Imura, Ishikawa (JP); Nobuo Kitagishi, Ishikawa (JP); Hiroshi Ootaguro, Ishikawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Minato-ku (JP)

(21) Appl. No.: 11/298,889

(22) Filed: Dec. 12, 2005

(30) Foreign Application Priority Data
Dec. 17, 2004 (JP) 2004-366713

(51) Int. Cl. G02F 1/1333

(52) U.S. Cl. 349/54

(57) ABSTRACT

A liquid crystal display device is equipped with an annular redundant wire that is formed to be nearer to the edge side of the array substrate than the respective outermost lines of plural scan lines and plural signal lines on the array substrate, surround all the scan lines and all the signal lines and cross each signal line through an insulating layer at two places. At least one of the signal lines has a wire-broken portion, and the redundant wire has recess portions at the two cross portions at which the redundant wire crosses the signal line having the wire-broken portion. The recess portions are embedded with a conductive material to thereby electrically connecting the redundant wire and the signal line having the wire-broken portion.

### CROSS-REFERENCE TO RELATED APPLICATIONS

This application is based upon and claims the benefit of priority from the prior Japanese Patent Application No. 2004-366713, field on Dec. 17, 2004; the entire contents of which are incorporated herein by reference.

### TECHNICAL FIELD

The present invention relates to a liquid crystal display device and a method of manufacturing the same, and particularly to a liquid crystal display device and a manufacturing method therefore that contains a wire defect repairing method.

### BACKGROUND OF THE INVENTION

For example, the following two methods have been known as a method of repairing breaking of a wire (hereinafter referred to as “repairing method”) when breaking occurs in a wire such as a signal line or the like.

A first repairing method is a method using laser CVD (chemical vapor deposition). According to this method, there are formed two breaking repairing contact holes through which an upper-side opening portion of a wiring pattern and space opening portions formed at both the sides of the wire pattern in the width direction thereof so as to reach the surface of the substrate intercommunicate with each other, and the breaking repairing contact holes are embedded with laser CVD films formed of organic metal compound. Then, the respective laser CVD films embedded in the two breaking repairing contact holes are connected to each other by a laser CVD film, or connected to the same pixel electrode by using a laser CVD method, or connected to different pixel electrodes by laser CVD films and then the pixel electrodes are connected to each other by a laser CVD film, or the connection between the signal line and the drain electrode of TFT connected to one or both of the pixel electrodes is broken.

A second repairing method is a method using laser welding. According to the second repairing method, no wire repairing contact hole is provided, a laser CVD film having a larger width than the wire pattern broken on the protection film at a wire-broken portion is formed so as to stride across the wire-broken portion, and a laser CVD film and both the end portions of the broken wire pattern are connected at both the end sides of the wire-broken portion by a laser welding method (for example, see JP-A-2002-182246).

The following effects can be achieved by using the above two repairing methods.

In the first repairing method, an nsulating film is dry-etched to form the breaking repairing contact holes before the pixel electrode is formed, and thus the pixel electrode is prevented from being contaminated by laser irradiation.

The second repairing method has an advantage that it is unnecessary to increase the number of masks and a repairing work can be carried out even at some midpoint of the process.

However, the first repairing method needs a step of coating a resist to form the breaking repairing contact holes.

Furthermore, the second repairing method has a drawback that it is impossible to carry out repairing well when the melt amount of the laser CVD film is lacking.

### BRIEF SUMMARY OF THE INVENTION

An object of the present invention is to provide a liquid crystal display device and a method of manufacturing the liquid crystal display device that can more simply and surely repair a wire-broken portion of a signal line without increasing the number of steps.

According to embodiments of the present invention, there is provided a liquid crystal display device comprising a pair of substrates including an array substrate and a counter substrate disposed so as to face the array substrate, and a liquid crystal layer sandwiched between the pair of substrates, the array substrate having, on one principal surface thereof, at least plural scan lines, plural signal lines disposed so as to be substantially perpendicular to the scan lines, and an annular redundant wire that is formed to be nearer to the edge side of the array substrate than the respective outermost lines of the plural scan lines and the plural signal lines, surround all the scan lines and all the signal lines and cross each signal line through an insulating layer at two places, at least one of the signal lines having a wire-broken portion, and the redundant wire having recess portions at the two cross portions at which the redundant wire crosses the signal line having the wire-broken portion and the recess portions being embedded with a conductive material to thereby electrically connecting the redundant wire and the signal line having the wire-broken portion.

Furthermore, according to an embodiment of the present invention, there is provided a method of manufacturing a liquid crystal display device comprising a pair of substrates including an array substrate and a counter substrate disposed so as to face the array substrate, and a liquid crystal display device sandwiched between the pair of substrates, the method comprising: forming, on the array substrate, signal lines and scan lines disposed perpendicularly to the signal lines; forming an annular redundant wire so that the annular redundant wire is nearer to the edge side of the array substrate than the respective outermost lines of the plural scan lines and the plural signal lines, surrounds all the scan lines and all the signal lines and cross each signal line through an insulating layer at two places; detecting the presence or absence of a wire breaking in each signal line; detecting at least two places at which the redundant wire and the signal line having the wire breaking thus detected cross each other; forming a recess portion at each of the two places thus detected; filling the recess portions thus formed with a conductive material; and setting one end of the redundant wire to a non-conductive state with the cross portions set as boundaries.

According to the present invention, the redundant wire has the recess portions at the two cross portions at which the redundant wire crosses the signal line having the wire-broken portion, and the recess portions are filled with the conductive material, thereby electrically connecting the redundant wire and the signal line having the wire-broken portion. Accordingly, the wire-broken portion of the signal line can be electrically connected by the redundant wire. Furthermore, since the redundant wire and the recess portions are merely provided, the number of steps is not increased.

### BRIEF DESCRIPTION OF THE DRAWINGS

FIG. 1 is a partial cross-sectional view showing a liquid crystal display device according to the present invention;

FIG. 2 is a plan view of an array substrate; and

FIGS. 3A to 3D are planar and cross-sectional views showing a manufacturing method according to the present invention.

### DETAILED DESCRIPTION OF THE INVENTION

Embodiments of the present invention will be described hereunder with reference to the accompanying drawings.

(1) Construction of Liquid Crystal Display Device 1

First, the construction of a liquid crystal display device 1 will be described.

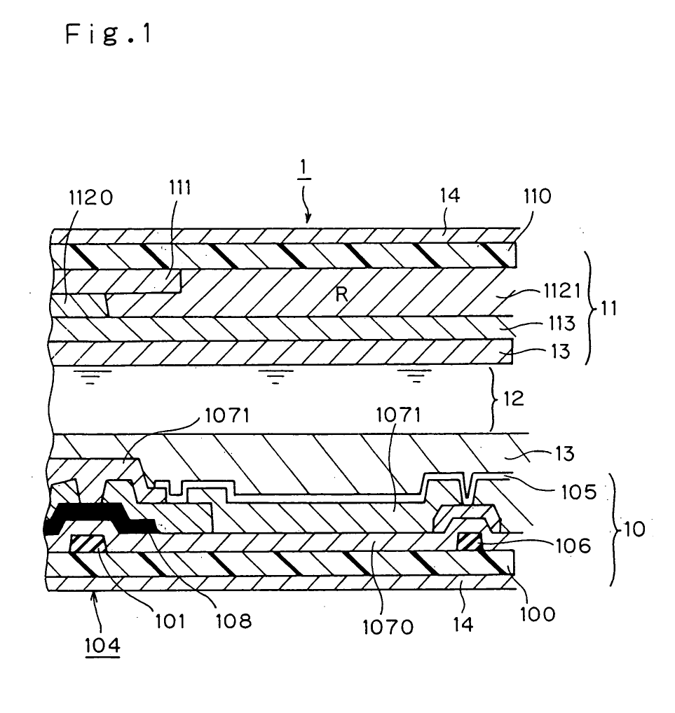

FIG. 1 is a partial cross-sectional view showing a transmission type liquid crystal display device according to an embodiment of the present invention.

The liquid crystal display device 1 includes an array substrate 10, a counter substrate 11 that is disposed so as to face the array substrate 10 and comprises a mesh-type black matrix 111 disposed on one principal surface of a glass substrate 110, three color filters 1120, 1121, 1122 (not shown) of three colors of red, green (G) and blue (B), a counter electrode 113 formed of ITO (Indium Tin Oxide) as a transparent electrode disposed on the respective color filters, a liquid crystal layer 12 sandwiched between the two substrates as a pair, an alignment film 13 formed on each of both the array substrate 10 and the counter substrate 11 to define the alignment of liquid crystal material constituting the liquid crystal layer 12, and polarizing plates 14 disposed on the opposite side surfaces of both the substrates to the contact surfaces thereof with the liquid crystal layer 12. Furthermore, bead spacers (not shown) for making the gap between the substrates uniform are sandwiched between the array substrate 10 and the counter substrate 11.

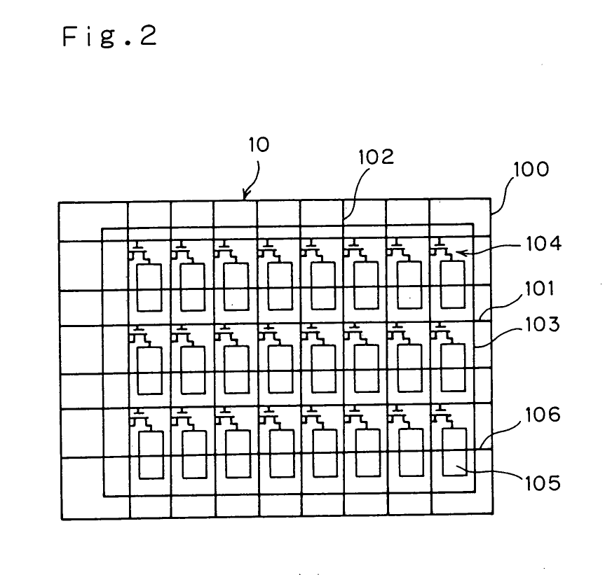

FIG. 2 is a plan view showing the array substrate serving as one of the paired substrates constituting the liquid crystal display device.

The array substrate 10 comprises plural scan lines 101 formed on one principal surface of the glass substrate 100, plural signal lines 102 formed on the scan lines 101 and arranged so as to be substantially perpendicular to the scan lines 101 through an insulating film 1070 as shown in FIG. 1, a redundant wire 103 formed so as to surround the peripheries of the scan lines 101 and the signal lines 102 two-dimensionally, thin film transistors 104 each of which is disposed in the neighborhood of the cross point between the scan line 101 and the signal line 102, and pixel electrodes 105 connected to the thin film transistors 104.

The thin film transistor 104 comprises a gate electrode connected to the scan line 101, an amorphous silicon layer as a semiconductor layer formed through an insulating film, a source electrode connected to the signal line 102 on the amorphous silicon layer, and a drain electrode directly connected to the pixel electrode.

(2) Method of Manufacturing Array Substrate 10

The array substrate 10 is manufactured according to the following manner.

Aluminum is depositted on the whole surface of one principal surface of the glass substrate 100 to form a metal film, and then the metal film is subjected to patterning to form the scan lines 101 and the annular redundant wire 103 as a repair wire. The redundant wire 103 is formed at a portion shielded by a shielding black matrix in the neighborhood of the four sides of the glass substrate 100.

Silicon nitride film is also formed on the above elements over the whole surface of the substrate to form the insulating film 1070.

Subsequently, amorphous silicon is deposited on the whole surface and then subjected to patterning to thereby form the amorphous silicon layer 108 as the semiconductor layer.

Subsequently, aluminum is further deposited on the whole surface to form a metal film, and then the metal film is subjected to patterning to form the source electrodes, the drain electrodes and the signal lines 102.

Subsequently, silicon nitride film is formed on the whole surface of the substrate, the insulating film 1071 is formed on the silicon nitride film, and then contact holes (not shown) for connecting the pixel electrodes 105 and the drain electrodes are formed.

Finally, ITO is deposited on the whole surface of the substrate to form the pixel electrode layer, and then the pixel electrode layer is subjected to patterning to form the pixel electrodes 105, thereby completing the array substrate 10.

(3) Repair Method of Array Substrate 10

When the array substrate 10 is completed, a wire-breaking test of the signal lines 102 is carried out by using an array tester. When a wire-broken portion exists in some signal line 102, and the wire-broken portion is detected by this test, the wire breaking is repaired by the following method.

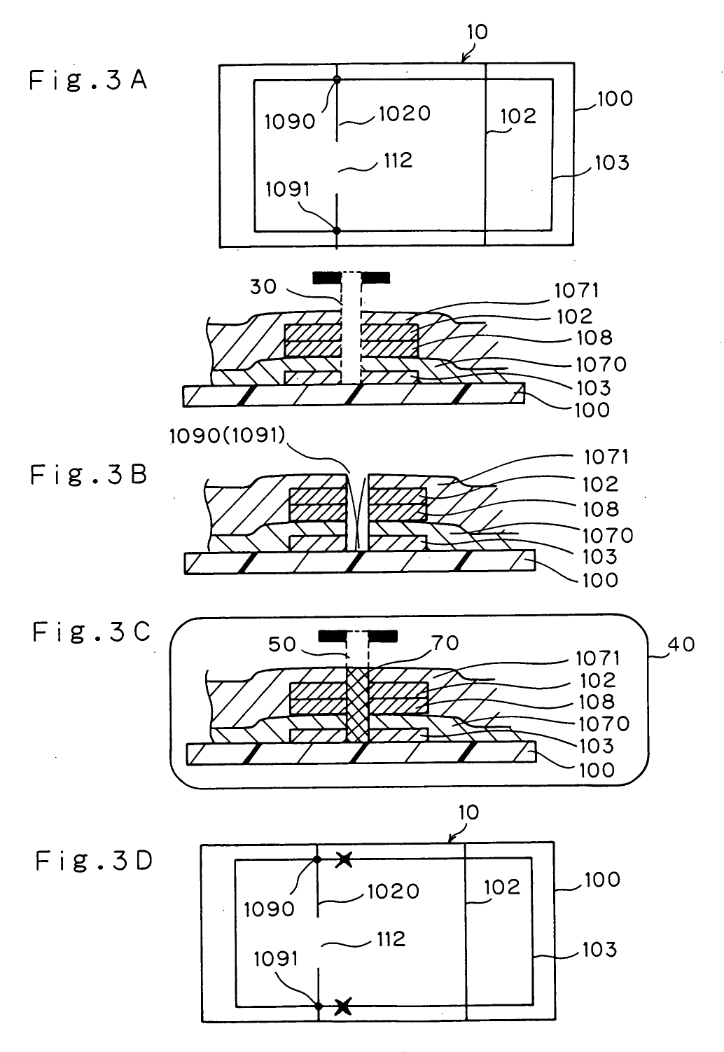

FIG. 3 is a diagram showing each step of the repair method of this embodiment.

When a signal line having a wire breaking is detected by the signal line breaking test, a pulse laser UV beam 30 is irradiated to each of points 1090, 1091 at which the signal line 1020 having the wire-broken portion 112 and the redundant wire 103 cross each other (FIG. 3A).

At this time, the pulse laser UV beam 30 may be irradiated by two shots under the condition of 0.5 to 0.9 mJ in power and 2.5 to 3 in frequency.

Accordingly, at the irradiation places 1090 and 1091 of the pulse laser UV beam 30, the insulating film 1071, the signal line 102, the redundant wire 103 and the lower-layer insulating film 1070 are molten (FIG. 3B). If the respective layers thus molten are left as they are for 10 seconds or more, they would be re-solidified under the above state.

Subsequently, W(CO)₆ atmosphere 40 of raw material gas is generated, and a CW (continuous oscillation) laser UV beam 50 is irradiated to the irradiation portions of the pulse laser UV beam 30 under the W(CO)₆ atmosphere 40.

At this time, the CW laser UV beam 50 may be irradiated for 10 to 13 seconds with power of 2.5 to 3.0 mW.

At this time, at the portions irradiated with the CW laser UV beam 50, the raw material gas 40 is solidified as tungsten from the gaseous state thereof, and deposited (FIG. 3C).

Accordingly, the perforated portions are molten by one laser irradiating operation to improve the electrical connection of the perforated portion, which has been insufficient merely by resolidification.

Subsequently, a longer part of the annular redundant wire 103 is cut at two end portions thereof with respect to the two laser beam irradiated portions as boundaries and set to a non-conductive state (FIG. 3D).

When the repair work is completed as described above, it is further checked by an array tester or a collective image test after a cell is assembled whether the repair work is successful or not.

As described above, not only the cross portions between the signal line 102 and the redundant wire 103 are molten by the pulse UV laser beam 30 and solidified, but also the recess portions thus formed are embedded with tungsten, whereby the conduction between the redundant wire 104 and the signal line 103 can be more greatly enhanced.

(Modification)

The present invention is not limited to the above embodiments, and various modifications may be made without departing from the subject matter of the present invention.

In the above embodiment, bead-type spacers which are designed in the form of beads and dispersed are used as the spacers, however, columnar spacers which are designed in the form of columnar shape may be used as the spacers.

In the above embodiment, the amorphous silicon layer as the semiconductor layer of the thin film transistor 104 is used. However, polysilicon may be used.

In the above embodiment, the description has been made by setting the thin film transistor structure to a bottom gate structure, however, it may by a top gate structure.

In the above embodiment, the recess portions are embedded with tungsten, however, the same effect can be achieved if chromium is formed in place of tungsten.

In the above embodiment, the annular redundant wire 103 is divided into two parts with the two laser-beam irradiated portions as boundaries, and a longer part of the divided redundant wire 103 are cut at two places of the end portions at the two places and set to a non-conductive state. However, it may be cut only at one place and set to be a non-conductive state.

What is claimed is:

1. A liquid crystal display device comprising:
a pair of substrates including an array substrate and a counter substrate disposed so as to face the array substrate; and a liquid crystal layer sandwiched between the pair of substrates, the array substrate having, on one principal surface thereof, at least plural scan lines, plural signal lines disposed so as to be substantially perpendicular to the scan lines, and an annular redundant wire that is formed to be nearer to the edge side of the array substrate than the respective outermost lines of the plural scan lines and the plural signal lines, surround all the scan lines and all the signal lines and cross each signal line through an insulating layer at two places, at least one of the signal lines having a wire-broken portion, and the redundant wire having recess portions at the two cross portions at which the redundant wire crosses the signal line having the wire-broken portion and the recess portions being embedded with a conductive material to thereby electrically connecting the redundant wire and the signal line having the wire-broken portion.

2. The liquid crystal display device according to claim 1, wherein the annular redundant wire is divided into two parts with the two cross portions as boundaries, and one part of the redundant wire is set to a non-conductive state.

3. The liquid crystal display device according to claim 1, wherein the conductive material is tungsten.

4. The liquid crystal display device according to claim 1, wherein the conductive material is chromium.

5. A method of manufacturing a liquid crystal display device comprising a pair of substrates including an array substrate and a counter substrate disposed so as to face the array substrate, and a liquid crystal display device sandwiched between the pair of substrates, comprising:
forming, on the array substrate, signal lines and scan lines disposed perpendicularly to the signal lines, and forming an annular redundant wire so that the annular redundant wire is nearer to the edge side of the array substrate than the respective outermost lines of the plural scan lines and the plural signal lines, surrounds all the scan lines and all the signal lines and cross each signal line through an insulating layer at two places;
detecting the presence or absence of a wire breaking in each signal line;
detecting at least two places at which the redundant wire and the signal line having the wire breaking thus detected cross each other;
forming a recess portion at each of the two places thus detected;
filling the recess portions thus formed with a conductive material; and
setting one end of the redundant wire to a non-conductive state with the cross portions set as boundaries.

6. The liquid crystal display device manufacturing method according to claim 5, wherein the recess portions are formed at two places at which the signal line having the wire-broken portion and the redundant wire cross each other.

7. The liquid crystal display device manufacturing method according to claim 5, wherein a longer part of the redundant wire with the two cross portions as boundaries is set to a non-conductive state.

8. The liquid crystal display device manufacturing method according to claim 5, wherein the conductive material is tungsten.

9. The liquid crystal-display device manufacturing method according to claim 5, wherein the conductive material is chromium.
